(19) United States
(12) Patent Application Publication
(10) Pub. No.: US 2013/0090955 A1
(43) Pub. Date: Apr. 11, 2013

(54) MANAGING AN INSURANCE PLAN

(71) Applicant: DISCOVERY HOLDINGS LIMITED, Sandton (ZA)

(72) Inventors: Adrian GORE, Sandton (ZA); Herschel Phillip MAYERS, Johannesburg (ZA); Kenneth RABSON, Johannesburg (ZA)

(73) Assignee: DISCOVERY HOLDINGS LIMITED, Sandton (ZA)

(21) Appl. No.: 13/648,309

(22) Filed: Oct. 10, 2012

(30) Foreign Application Priority Data
Oct. 10, 2011 (ZA) 2011/07402

(51) Int. Cl. G06Q 40/08

(52) U.S. Cl. CPC G06Q 40/08
USPC 705/4

(57) ABSTRACT

A method of managing an insurance policy uses at least one computer to execute software stored on non-volatile memory. The software is configured for accessing at least one benefit amount data to be paid out to the insured person on the occurrence of an insured event defined under the policy; receiving premium related data relating to a premium paid by the insured person for the at least one benefit amount; storing the benefit amount data and premium data in a database; defining an additional benefit amount to be paid in addition to the benefit amount if an insured event occurs within a predetermined future period of time; zeroing an additional premium amount for the predetermined period of time; processing health data and/or safety data, the health data relating to the use of a plurality of health related facilities and/or services by the insured person for the predetermined period of time and the safety data relating to the compliance of an individual with a safety program; and calculating, using the health data and/or safety data and the benefit amount and premium data, an additional premium amount to be paid for an additional benefit cover to be payable if an insured event occurs after the predetermined period of time.

### CROSS-REFERENCE TO RELATED APPLICATIONS

This application claims priority to South African Patent Application Number 2011/07402 filed Oct. 10, 2011, the contents of which are hereby incorporated by reference.

### FIELD OF THE INVENTION

The present invention relates to a managing an insurance plan, and more particularly to providing additional incentives for healthful and safe behaviour of insureds.

### BACKGROUND

Individuals are able to purchase fixed amounts of life, disability or severe illness insurance before an insured event, to be paid out on the occurrence of the event, for example a severe illness or disability.

To reduce claims, and improve the health of insureds, programs provide incentives to encourage healthful behaviour, including participation in a wellness program which may include using health related facilities or services.

### SUMMARY OF THE INVENTION

According to one example embodiment, a method of managing an insurance policy, the method including: defining at least one insured event for an insured person and at least one benefit amount to be paid out to the insured person on the occurrence of the insured event; receiving premium related data relating to a premium paid by the insured person for the at least one benefit amount; storing the insured event, benefit amount and premium data in a database; defining an additional benefit amount to be paid in addition to the benefit amount if an insured event occurs within a predetermined future period of time; zeroing an additional premium amount for the predetermined period of time; processing health data and/or safety data, the health data relating to the use of a plurality of health related facilities and/or services by the insured person for the predetermined period of time and the safety data relating to the compliance of an individual with a safety programme; and using the health data and/or safety data to determine an additional premium amount to be paid for the additional benefit cover to be payable if an insured event occurs after the predetermined period of time.

The plurality of health-related facilities and/or services may include at least one of the group consisting of membership of health clubs, membership of gymnasiums, membership of fitness programs, weight loss programs and programs to quit smoking.

The plurality of health-related facilities and/or services may further include predetermined preventive medical procedures.

The plurality of health-related facilities and/or services may also further include a medical advice service and predetermined procedures, for example at least one of the group consisting of advance pre-authorization of hospitalization, advance pre-authorization of treatment, registration for electronic funds transfer and compliance with preferred procedures.

According to another example embodiment there provided an electronic system for managing an insurance policy, the system including: a benefit module defining at least one insured event for an insured person and at least one benefit amount to be paid out to the insured person on the occurrence of the insured event and for defining an additional benefit amount to be paid in addition to the benefit amount if an insured event occurs within a predetermined future period of time; a premiums module for receiving premium related data relating to a premium paid by the insured person for the at least one benefit amount and for zeroing an additional premium amount for the predetermined period of time; a database for storing the insured event, benefit amount and premium data; a health module to process health and/or safety data, the health data relating to the use of a plurality of health related facilities and/or services by the insured person for the predetermined period of time and the safety data relating to the compliance of an individual with a safety programme; and a calculation module for using the health data and/or safety data to determine an additional premium amount to be paid for the additional benefit cover to be payable if an insured event occurs after the predetermined period of time.

The health module may process health data wherein the plurality of health-related facilities and/or services includes at least one of the group consisting of membership of health clubs, membership of gymnasiums, membership of fitness programs, weight loss programs and programs to quit smoking.

The health module may further process health data wherein the plurality of health-related facilities and/or services further includes predetermined preventive medical procedures.

In addition, the health module may process health data wherein the plurality of health-related facilities and/or services also further includes a medical advice service and predetermined procedures, for example at least one of the group consisting of advance pre-authorization of hospitalization, advance pre-authorization of treatment, registration for electronic funds transfer and compliance with preferred procedures.

### BRIEF DESCRIPTION OF THE DRAWINGS

A more complete understanding of the present invention, and the attendant advantages and features thereof, will be more readily understood by reference to the following detailed description when considered in conjunction with the accompanying drawings, in which:

FIG. 1 is a flow chart illustrating the methodology of an example embodiment;

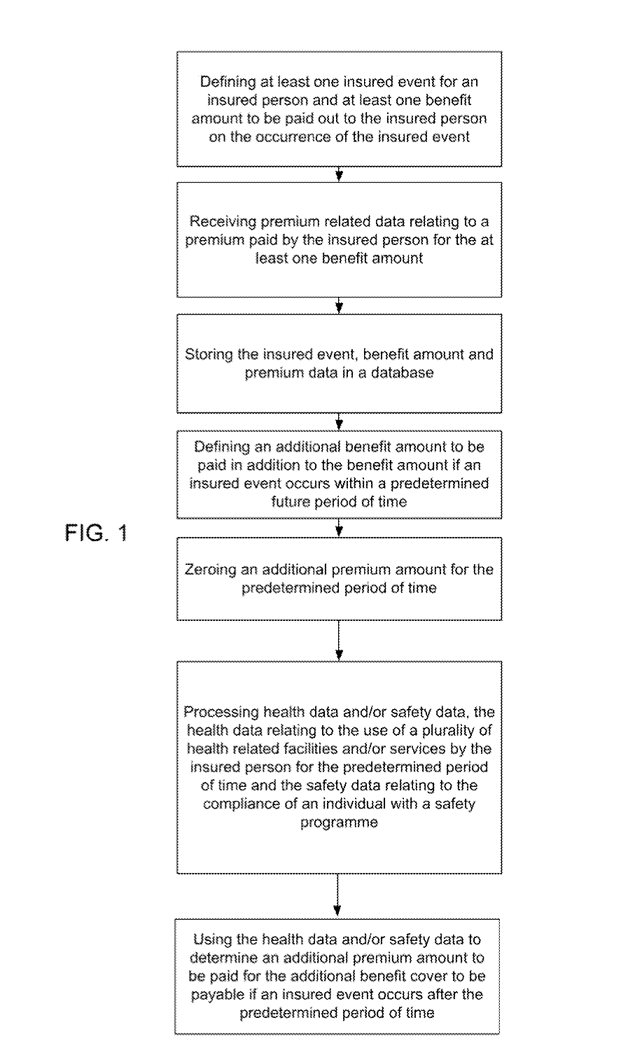

FIG. 2 is a block diagram illustrating an example system to implement the methodologies described herein; and

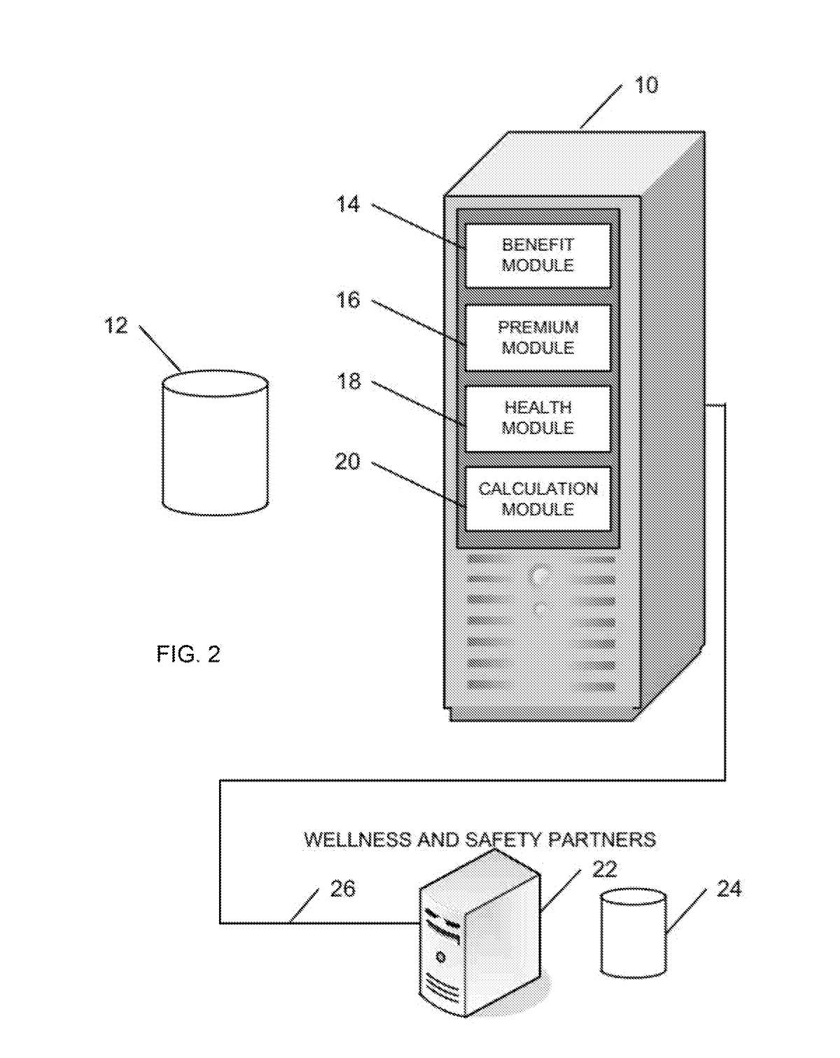

FIG. 3 illustrates a system architecture for a computer system such as a server, work station or other processor on which the disclosure may be implemented.

### DETAILED DESCRIPTION OF THE INVENTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language).

The present disclosure provides motivation for insured persons to look after their wellness.

In accordance with the disclosure, the systems and methodology described herein relate to managing an insurance plan. It will also be appreciated that the system and methodology may be implemented by any relevant person or organisation. For example, the system and methodology may be operated by the insurer. Alternatively, the system and methodology may be operated by a third-party consultant to the insurer. For purposes of illustration, the system and methodology will be described herein as being operated by the managers of a life insurance plan.

Thus, one example application for the system and method described herein may be in the field of managing the business and operation of a life insurance plan. Typically, the insurer of such plans undertakes liability in return for a premium or contribution, and insures members who pay such premiums or make such contributions against the occurrence of an insured event. The insured event may be, for example, death, disability or severe illness.

Referring to the accompanying Figures, a method of managing an insurance policy is described. A server 10 includes a number of modules. The modules described below may be implemented by a machine-readable medium embodying instructions which, when executed by a machine, cause the machine to perform any of the methods described above.

It will be appreciated that embodiments of the present invention are not limited to such architecture, and could equally well find application in a distributed, or peer-to-peer, architecture system. Thus the modules illustrated could be located on one or more servers operated by one or more institutions.

In any event, the method includes defining, by a benefit module 14, at least one insured event for an insured person and at least one benefit amount to be paid out to the insured person on the occurrence of the insured event. So for example, the benefit may be the payment of R1,000,000 upon the death of the insured person. It will be appreciated that in this case the payment will be made to the nominated beneficiary of the insured person.

It will be appreciated that in return for the insurance, the insured person will pay a premium to the insurer. The premium may be a lump sum paid up front, or alternatively may be a periodic payment which will typically be a monthly or annual payment. In any event, a premium module 16 determines a premium to be paid by the insured person for the at least one benefit amount. The premium for R1,000,000 life cover could be R1,000 per month, for example.

The insured event, benefit amount and premium data are stored in a database 12 associated with server 10. An additional benefit amount is now defined by the benefit module 14. This additional benefit amount is to be paid in addition to the benefit amount if an insured event occurs within a predetermined period of time.

For example, the additional benefit amount may be a 40% additional benefit and the predetermined future period may be 3 years. In this case, on the occurrence of an insured event in the 3 year period, the nominated beneficiary would be paid R1,400,000.

The premium module 16 zeros (sets to zero) an additional premium amount for the predetermined period of time and so effectively the insured person for this predetermined future period of time obtains free additional cover. During this future predetermined period of time, the use by the insured person of a wellness program is monitored by the health module 18.

The wellness program at least includes a plurality of health related facilities and/or services and alternatively or in addition a safety program.

The monitoring may be done directly or indirectly where the health module receives usage data relating to the usage of health related facilities and/or services from one or more third party service providers that are providing the health related facilities and/or services.

An example of such a wellness program is presently managed by the applicant and is their so-called Vitality™ program disclosed in the applicant's co-pending U.S. patent publication Ser. No. 09/982,274, the contents of which are incorporated herein by reference.

The Vitality program rewards members for utilizing approved health related facilities and/or services. For example, members are rewarded for utilizing membership of health clubs, membership of gymnasiums, membership of fitness programs, weight loss programs and programs to quit smoking.

Members are also rewarded for using preventive medical procedures, medical advice services and predetermined procedures, for example, pre-authorization of hospitalization, advance pre-authorization of treatment, registration for electronic funds transfer and compliance with preferred procedures.

Members are rewarded by a points allocation system and depending on the total number of points allocated to a member, they fall within one of five statuses. In the implementation of the Vitality program, these statuses have been named in ascending order of value, blue, bronze, silver, gold and diamond. All members are placed initially in the blue status. Once a member has accumulated a predetermined number of points, his/her Vitality status is upgraded to the next appropriate level.

In any event, the health module 18 processes health data relating to the use of a plurality of the health related facilities and/or services by the insured person. The health data typically includes the use that the insured person is making of the health related facilities and/or services. It will be appreciated that the processing of this health data, in one example, includes receiving the data input by a user or an independent system and storing the health data in the database 12.

In addition, the health data may be received, via a communications network 26, from a server 22 of a third party health partner with an associated database 24. In this example, the third party health partner may be the operator of a gymnasium or weight loss program, for example, that captures this data and uploads the data to the health module 18.

The health module 18, either independently or in conjunction with other modules, uses the health data to calculate the insured person's Vitality status as has been described above.

The calculation module 20 then uses this to calculate the additional premium amount as follows.

Using the above example, the extra benefit cover will remain free for 3 years. At the end of the 3 years, the system we will analyze how the insured person managed his wellness over that period to determine the additional premium amount and will allow him to continue that cover at the additional premium amount.

In one example, the additional premium amount is a discounted rate, for example as follows:

| Vitality Status | Discount applicable |
|---|---|
| Blue | 0% |
| Bronze | 5% |
| Silver | 10% |
| Gold | 12.5% |
| Diamond | 15% |

Thus, if the insured person is Silver Status at the end of the 3 years, he will be able to continue with this extra cover at a 10% discount from years 4 onwards.

Alternatively or in addition, the health module 18 monitors safety data relating to a safety program. The safety program may be any relevant safety program but in one illustrated embodiment relates to a safe driver program. In this example, the insured person is the driver of a vehicle.

An example of such a program is described in the applicant's published and co-pending PCT patent application PCT/IB2011/051604, the contents of which are incorporated herein by reference.

As described therein, driver behaviour is determined by assessing the driver performance in a plurality of program areas. These plurality of program areas include at least one of vehicle maintenance, driver education and driving performance. In one example embodiment, the plurality of program areas includes all of the abovementioned program areas. The program area of vehicle maintenance includes one or more of servicing the vehicle, checking the vehicle and checking the vehicles tires.

Describing these program areas in more detail, servicing the vehicle means that the driver has taken the vehicle to a mechanical workshop for a periodic service to ensure that the vehicle is in good working order. Typically in such services oil and other lubricants are changed, brake pads are changed if required and any other mechanical faults that have arisen in the past period are fixed.

The program area of checking the vehicle entails taking the vehicle to an authorised center where a number of checks on the different parts of the vehicle are conducted to ensure that the vehicle is in good working order. If anything is found to be not correct, the driver will be instructed to take the vehicle to a workshop for fixing and may be awarded further points for this step. New vehicles may be exempt from the service check for the first year and the insured person will be awarded these points on submission of proof that the vehicle is within its first year since its first registration. Checking the vehicle tires entails either having the tires checked as part of the above-mentioned checking of the vehicle or alternatively, taking the vehicle to a specialist tire center to have the tires checked.

In one example embodiment, an interface is created between the server 10 and a checking center via communications network 26 so that the checking center can confirm the results of the check. In addition to the tire check, the steering, windscreen wipers, lights, seatbelts, horn and shock absorbers can be checked at this time.

The program area of driver education includes one or more of a driving course, a driver assessment, a periodic driver quiz and a carbon footprint calculation. Driving courses are attended by drivers to improve their driving skills and particularly to learn defensive driving skills. A driver assessment is conducted in one example embodiment by an assessor taking the driver in the vehicle onto the road and assessing the driving skills and habits of the driver.

Weaknesses in the skills or habits of the driver may be pointed out and the driver given the opportunity to correct these in the coming weeks or months before returning for an updated assessment. In one example, the driver is given an assessment score.

In another example, the driver assessment is an online questionnaire designed to highlight certain risks relating to a driver. In this example, the questionnaire includes two sections namely. ‘Driving habits’ and ‘State of Vehicle’. For example a question of whether one uses a cellular telephone to send messages while driving will be asked. At the end of the questionnaire (approximately 20 questions) the driver will receive feedback explaining their risk and suggesting ways to mitigate their risks.

Based on the answers received a calculation will be performed to consider the driver's risk relative to an average driver. The results can be illustrated to the driver on two risk bars. One illustrates how risky the driver's habits are, and one illustrates risks relating to the state of the drivers vehicle. A third risk bar may also be included illustrating a combined risk score.

In addition, the questionnaire may include educational information to address specific areas such as how to drive in wet weather or what to do in the event of an accident. The format will be a paragraph followed by a question relating to the paragraph. In this example, the driver will typically use a user interface device in the form of a computer with a screen on which is displayed a template for the driver to capture answers to questions asked.

The answers are captured and transmitted to the server 10. Alternatively, the server 10 accesses driver information stored in the database 12 and obtains the driver's e-mail address. An e-mail is then sent to the retrieved e-mail address. When the driver opens the e-mail a template is displayed to them asking them the relevant questions with options to select various scores. The driver will send the e-mail back to the server 10 via a communications network. These will be received and written to the database.

The program area of driving score includes monitoring the manner in which the motor vehicle is driven. In one example embodiment this is implemented using data received from a telematics device associated with a vehicle which is the vehicle that the driver uses. It will be appreciated that in one example the telemetry device will be installed in the motor vehicle either at the time of production or retro-fitted.

The telemetry device is used to monitor a number of aspects of the use of the motor vehicle. For example, the device monitors the speed at which the vehicle is travelling and can therefore calculate average speed and maximum and minimum speeds, for example. Where the device includes GPS functionality, for example, the device is able to determine if speed limits on a particular road have been exceeded.

The device is also able to determine braking habits of the driver either using the GPS functionality or by using an accelerometer or having one or more sensors connected to the vehicle or to a deceleration detection device, for example. The device is also typically able to detect the distance traveled and if the driver has driven the vehicle for a long time period without a break. In addition, the times of the day that the vehicle is being driven can be captured as night time driving is statistically more dangerous than day time driving, especially weekend late night driving.

In addition to the above, the device will have the ability to detect the driver's use of the vehicle including braking, indicating, cornering and accelerating to name a few examples. Thus, it could be determined when the vehicle turns without indicating, for example.

In any event, the safety data from the device is transmitted to the server 10 over a communication network. It will be appreciated that this could be accomplished in a number of ways. For example, the data could be transmitted via the communication network 26 as illustrated in the accompanying drawing. Alternatively, the communication network could be any suitable kind of communication network such as a mobile communication network, a wireless communication network, a satellite communication network or a combination of these to name but a few examples.

Alternatively, the telemetry device could be connected to another intermediate device which downloads the data and transmits the data via the communication network to the server 10. One example of this could be connecting the telemetry device to a USB port of a computer and downloading the data to the computer, which data is then transmitted over the Internet to the server 10. In one example embodiment, the safety data is transmitted over a mobile phone network using the short message service (SMS) protocol.

It will be appreciated that the safety data could be transmitted at any suitable time to the server. For example, the safety data could be transmitted in real time or near real time or could be transmitted periodically such as daily, weekly or monthly to name a few examples. Once the server 10 receives the safety data it will analyse the data to determine the manner in which the motor vehicle has been driven for a past predetermined period.

To do this the calculation module 20 accesses the memory 12 and retrieves the data stored therein. The retrieved data is then used to determine a driving score. For example, the driver starts on a higher number of points which is reduced for each driving infraction, such as each harsh braking, speeding or late night driving instance as can be predetermined by the system managers. The score can in turn be used to determine the additional premium amount to be paid for the additional benefit cover to be payable if an insured event occurs after the predetermined period of time.

It will be appreciated that the safety and health factors could be used independently as has been described above or alternatively could be used in conjunction with one another to determine the additional premium amount. Where used in conjunction, the health and safety factors could be weighted equally or could be given different weightings depending on what the insurer wants the insured person to focus their efforts more or less on.

In any event, an advantage of the method described herein is that the insured person gets to “test run” the extra cover for a short period for free with no obligations. After the initial test run period, if they choose to keep it, then a discount will be applied provided that they are engaging in healthy and/or safety activities.

Exemplary Computer System

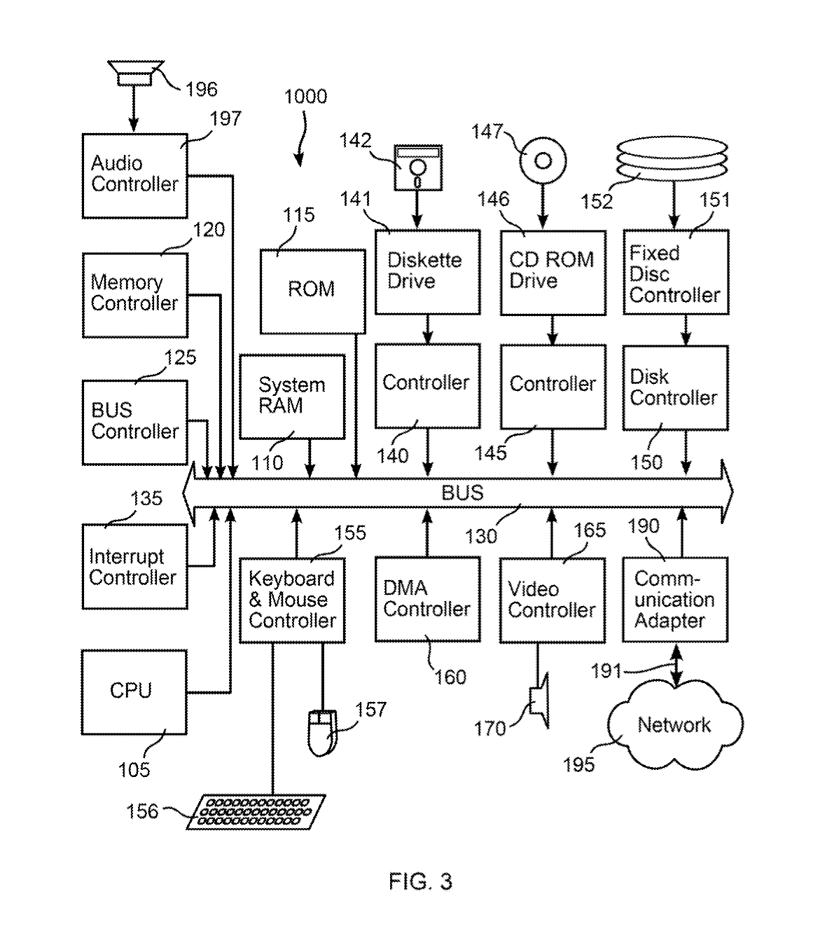

FIG. 3 illustrates the system architecture for a computer system 1000 such as a server, work station or other processor on which the disclosure may be implemented. The exemplary computer system of FIG. 3 is for descriptive purposes only. Although the description may refer to terms commonly used in describing particular computer systems, the description and concepts equally apply to other systems, including systems having architectures dissimilar to FIG. 3.

Computer system 1000 includes at least one central processing unit (CPU) 105, or server, which may be implemented with a conventional microprocessor, a random access memory (RAM) 110 for temporary storage of information, and a read only memory (ROM) 115 for permanent storage of information. A memory controller 120 is provided for controlling RAM 110.

A bus 130 interconnects the components of computer system 1000. A bus controller 125 is provided for controlling bus 130. An interrupt controller 135 is used for receiving and processing various interrupt signals from the system components.

Mass storage may be provided by diskette 142, CD or DVD ROM 147, flash or rotating hard disk drive 152. Data and software, including software 400 of the disclosure, may be exchanged with computer system 1000 via removable media such as diskette 142 and CD ROM 147. Diskette 142 is insertable into diskette drive 141 which is, in turn, connected to bus 30 by a controller 140. Similarly, CD ROM 147 is insertable into CD ROM drive 146 which is, in turn, connected to bus 130 by controller 145. Hard disk 152 is part of a fixed disk drive 151 which is connected to bus 130 by controller 150. It should be understood that other storage, peripheral, and computer processing means may be developed in the future, which may advantageously be used with the disclosure.

User input to computer system 1000 may be provided by a number of devices. For example, a keyboard 156 and mouse 157 are connected to bus 130 by controller 155. An audio transducer 196, which may act as both a microphone and a speaker, is connected to bus 130 by audio controller 197, as illustrated. It will be obvious to those reasonably skilled in the art that other input devices, such as a pen and/or tablet, Personal Digital Assistant (PDA), mobile/cellular phone and other devices, may be connected to bus 130 and an appropriate controller and software, as required. DMA controller 160 is provided for performing direct memory access to RAM 110. A visual display is generated by video controller 165 which controls video display 170. Computer system 1000 also includes a communications adapter 190 which allows the system to be interconnected to a local area network (LAN) or a wide area network (WAN), schematically illustrated by bus 191 and network 195.

Operation of computer system 1000 is generally controlled and coordinated by operating system software, such as a Windows system, commercially available from Microsoft Corp., Redmond, Wash. The operating system controls allocation of system resources and performs tasks such as processing scheduling, memory management, networking, and I/O services, among other things. In particular, an operating system resident in system memory and running on CPU 105 coordinates the operation of the other elements of computer system 1000. The present disclosure may be implemented with any number of commercially available operating systems.

One or more applications, such as an HTML page server, or a commercially available communication application, may execute under the control of the operating system, operable to convey information to a user.

All references cited herein are expressly incorporated by reference in their entirety. There are many different features to the present disclosure and it is contemplated that these features may be used together or separately. Unless mention was made above to the contrary, it should be noted that all of the accompanying drawings are not to scale. Thus, the invention should not be limited to any particular combination of features or to a particular application of the disclosure. Further, it should be understood that variations and modifications within the spirit and scope of the invention might occur to those skilled in the art to which the invention pertains. Accordingly, all expedient modifications readily attainable by one versed in the art from the disclosure set forth herein that are within the scope and spirit of the present invention are to be included as further embodiments of the present invention.

1. A method of managing an insurance policy, including:
using at least one computer to execute software stored on non-volatile memory, the software configured for:
accessing at least one benefit amount data to be paid out to the insured person on the occurrence of an insured event defined under the policy;
receiving premium related data relating to a premium paid by the insured person for the at least one benefit amount;
storing the benefit amount data and premium data in a database;
defining an additional benefit amount to be paid in addition to the benefit amount if an insured event occurs within a predetermined future period of time;
zeroing an additional premium amount for the predetermined period of time;
processing health data and/or safety data, the health data relating to the use of a plurality of health related facilities and/or services by the insured person for the predetermined period of time and the safety data relating to the compliance of an individual with a safety program; and
calculating, using the health data and/or safety data and the benefit amount and premium data, an additional premium amount to be paid for an additional benefit cover to be payable if an insured event occurs after the predetermined period of time.

2. A method according to claim 1 where the plurality of health-related facilities and/or services includes at least one of the group consisting of membership of health clubs, membership of gymnasiums, membership of fitness programs, weight loss programs and programs to quit smoking.

3. A method according to claim 1 wherein the plurality of health-related facilities and/or services further includes predetermined preventive medical procedures.

4. A method according to claim 1 wherein the plurality of health-related facilities and/or services further includes a medical advice service and predetermined procedures.

5. A method according to claim 4 wherein the predetermined procedures includes at least one of the group consisting of advance pre-authorization of hospitalization, advance pre-authorization of treatment, registration for electronic funds transfer and compliance with preferred procedures.

6. A method according to claim 1 wherein the safety program relates to a safe driver program.

7. A system for managing an insurance policy, the system including:
at least one computer to execute software stored on non-volatile memory, the software configured for:
accessing at least one benefit amount to be paid out to the insured person on the occurrence of an insured event defined under the policy;
defining an additional benefit amount to be paid in addition to the benefit amount if an insured event occurs within a predetermined future period of time;
receiving premium related data relating to a premium paid by the insured person for the at least one benefit amount;
zeroing an additional premium amount for the predetermined period of time;
storing the insured event, benefit amount and premium data;
processing health data and/or safety data, the health data relating to the use of a plurality of health related facilities and/or services by the insured person for the predetermined period of time and the safety data relating to the compliance of an individual with a safety program; and
calculating, using the health data and/or safety data and the stored benefit amount and premium data, an additional premium amount to be paid for the additional benefit cover to be payable if an insured event occurs after the predetermined period of time.

8. A system according to claim 7 wherein the health module processes health data wherein the plurality of health-related facilities and/or services includes at least one of the group consisting of membership of health clubs, membership of gymnasiums, membership of fitness programs, weight loss programs and programs to quit smoking.

9. A system according to claim 7 wherein the health module may further process health data wherein the plurality of health-related facilities and/or services further includes predetermined preventive medical procedures.

10. A system according to claim 9 wherein the health module processes health data wherein the plurality of health-related facilities and/or services also further includes a medical advice service and predetermined procedures, for example at least one of the group consisting of advance pre-authorization of hospitalization, advance pre-authorization of treatment, registration for electronic funds transfer and compliance with preferred procedures.

11. A system according to claim 7, wherein the health module processes safety data relating to a safe driver program.
